(19) United States
(12) Patent Application Publication
(10) Pub. No.: US 2002/0056122 A1
(43) Pub. Date: May 9, 2002

(54) Network system for distributing video information to clients

(76) Inventors: Kozo Yokoyama, Kawasaki (JP); Tomonori Hirose, Kanagawa (JP); Yuuji Takenaka, Kawasaki (JP); Hirotaka Tashima, Kawasaki (JP)

Correspondence Address: ROSENMAN & COLIN LLP, 575 MADISON AVENUE, NEW YORK, NY, 10022-2585, US

(21) Appl. No.: 09/792,834

(22) Filed: Feb. 23, 2001

(30) Foreign Application Priority Data
Feb. 29, 2000 (JP) 2000-54217

(51) Int. Cl. H04N 7/173

(52) U.S. Cl. 725/87; 725/98

(57) ABSTRACT

A network system according to the present invention comprises an IP encoder connected with a plurality of clients through a network. The IP encoder compresses and encodes inputted video information, forms a packet comprising the compressed and encoded video information, and multicasts the formed video information to the plurality of clients.

### BACKGROUND OF THE INVENTION

1. Field of the Invention

The present invention relates to a network system and, more particularly, to a network system for distributing video (movie) information to clients through a network.

2. Description of the Related Art

In the field of a conventional monitor system using a network, when a video is shot by a camera is distributed to a plurality of clients, a video signal (video information) transmitted from the camera is temporarily stored in a storage device of a server. Thereafter, the server distributes the stored video information to each of the clients through the network.

In the monitor system, display contents in a client require real-time properties. More specifically, a delay time from when a video is shot to when the video is displayed on the display device of the client is preferably short.

However, the conventional technique has the following problem. More specifically, in the conventional technique, a server unitarily stores pieces of video information from a plurality of cameras in a storage device and, at the same time, distributes the video information stored in the storage device to a plurality of clients. For this reason, an amount of data per unit time which can be stored in the storage device by the server is limited. In addition, since the server executes a storing process and a distributing process at the same time, a processing load on the server is large, and an amount of data per unit time which can be distributed by the server is limited. Therefore, the length of the delay time when from the video is shot to when the video is displayed can not neglect.

In addition, in the conventional technique, the clients request the server to redistribute the stored video information as needed. For the requests, the server executes a process for redistributing the video information, a load on the server increases, and the speeds of the storing process and the distributing process decrease. As a result, the delay time from the shooting to the displaying lengthen.

### SUMMARY OF THE INVENTION

It is an object of the present invention to provide a network system which can make a time for distributing video information to clients shorter than that of a conventional system.

The first aspect of the present invention employs the following configuration to achieve the above object. More specifically, the present invention is a network system for distributing video information to a plurality of clients comprising a network for accommodating the plurality of clients, and an encoder connected to the network, wherein the encoder comprises a compression coding unit compressing and encoding to input video information, a packet forming unit forming a packet comprising the video information which is compressed and encoded, and a transmission unit multicasting the formed packet to the plurality of clients through the network.

According to the present invention, since the video information is transmitted to the clients without being temporarily stored by a video server, display delay caused by a conventional storing process by a server does not occur. Therefore, a time from when the video information is acquired to when the video information is displayed can be shortened, real-time properties which can obtain a display more proper than that of a conventional system can be secured.

In the present invention, part or all of the video information stored in the storage device may be stored by another storage device. The other storage device is a video server which is connected to the network, collects and stores the video information stored in the storage device, and distributes the stored video information at requests from clients.

According to the present invention, the compression coding unit of the encoder may compress and encode a plurality of input video signals (a plurality of video information). More specifically, the compression coding unit may compress and encode to a plurality of video signals outputted from a certain video input device, and may compress and encode a plurality of video signals respectively transmitted from a plurality of video input devices.

The second aspect of the present invention is a network system for distributing video information to a plurality of clients, comprising: an encoder compressing and encoding inputted video information, forming a packet comprising the compressed and encoded, and transmitting the formed packet to a network; and a concentrater accommodating the plurality of clients through communication lines, receiving the packet transmitted by the encoder through the network, and muluticasting the received packet to the plurality of clients.

The third aspect of the present invention is an encoder for distributing video information to a plurality of clients through a network, comprising: a compression coding unit compressing and encoding inputted video information; a packet forming unit forming a packet comprising the compressed and encoded video information; and a transmission unit multicasting the formed packet to the plurality of clients.

### BRIEF DESCRIPTION OF THE DRAWINGS

FIG. 1 is a diagram of the entire configuration of a network system according to an embodiment.

FIGS. 2A and 2B are diagrams of IP encoders shown in FIG. 1.

FIG. 3 is an illustration showing a display example of a live screen.

FIG. 4 is an illustration showing a display example of a video-on-demand screen.

FIG. 5 is an illustration showing a display example of a video-on-demand screen.

FIG. 6 is a diagram for explaining an operation example of in the network system shown in FIG. 1.

FIG. 7 is a diagram for explaining an operation example of an on-demand display in the network system shown in FIG. 1.

FIG. 8 is a diagram showing another configuration of a network system.

### DESCRIPTION OF THE PREFERRED EMBODIMENT

A preferred embodiment of the present invention will be described below with reference to the accompanying drawing.

[Entire Configuration of Network System]

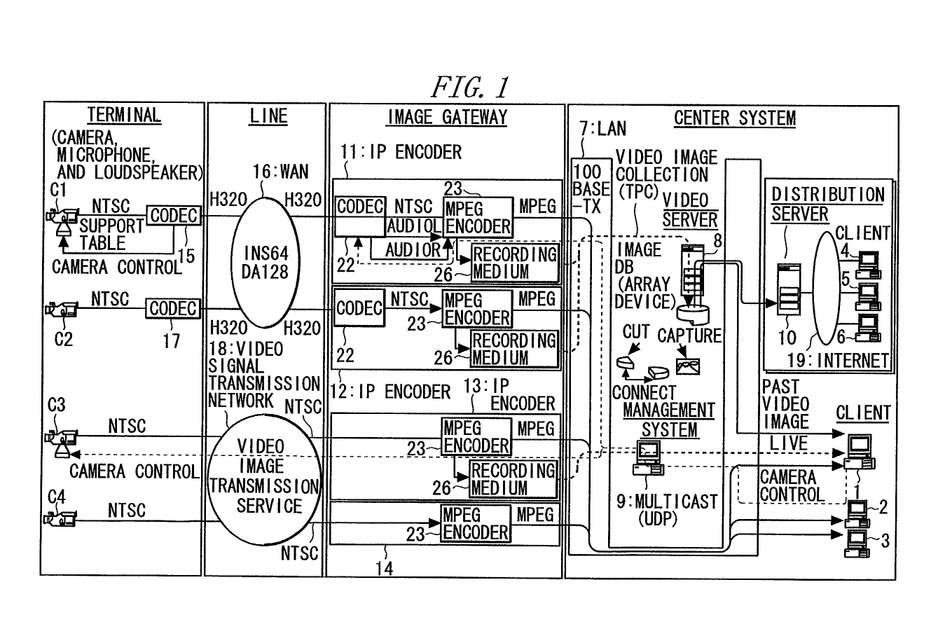

FIG. 1 is a diagram of the configuration of a network system according to the embodiment of the present invention. The network system shown in FIG. 1 is used as a monitor system for monitoring video images photographed by a plurality of cameras C1 to C4 (corresponding to video input devices according to the present invention) by first clients 1 to 3.

The concrete configuration is as follows. The first clients 1 to 3 are accommodated in a LAN (100 BASE-TX: corresponding to the network according to the present invention) 7. The LAN 7 also accommodates a video server 8 (corresponding to another storage device according to the present invention), a management system (corresponding to the management device according to the present invention) 9, and a distribution server 10. The LAN 7, the first clients 1 to 3, the video server 8, the management system 9, and the distribution server 10 constitute a center system in the monitor system.

The LAN 7 accommodates IP encoders 11 to 14 (corresponding to the encoder according to the present invention), and video images (video information) from the cameras C1 to C4 are distributed to the first clients 1 to 3 through the LAN 7.

The IP encoder 11 is connected to the camera C1 through a CODEC 15 and a WAN (e.g., INS64 or DA128) 16. The IP encoder 12 is connected to the camera C2 through a CODEC 17 and a WAN 16 (corresponding to another network according to the present invention). The IP encoder 13 is connected to a camera C3 through a video signal transmission network (video signal transmission network) 18. The IP encoder 14 is connected to the camera C4 through the video signal transmission network 18.

The distribution server 10 is connected to second clients 4 to 6 through the Internet 19. The constituent elements shown in FIG. 1 will be independently described below.

<Camera>

The cameras C1 to C4 are arranged at specific monitoring positions to photograph events occurring at the monitoring positions. For example, when the monitor system according to the embodiment is used as a monitor system for a traffic state, the cameras C1 to C4 are arranged at junctions or the like, respectively.

Each of the cameras C1 to C4 has a microphone and a loudspeaker, and outputs an NTSC signal including a photographed video image (video) and a sound.

The NTSC signal output from the camera C1 is input to the CODEC 15, and the NTSC signal output from the camera C2 is input to the CODEC 17. On the other hand, the NTSC signals output from the cameras C3 and C4 are received by the IP encoder 13 or the IP encoder 14 through the video signal transmission network 18.

<CODEC>

The CODECs 15 and 17 convert the NTSC signal output from the camera C1 or the camera C2 into a transmission signal (to be referred to as an “H. 320 signal” hereinafter) based on a protocol of H. 320, and outputs the converted H. 320 signal. The H. 320 signals output from the CODECs 15 and 17 are received by the IP encoder 11 or the IP encoder 12 through the WAN 16.

<IP Encoder>

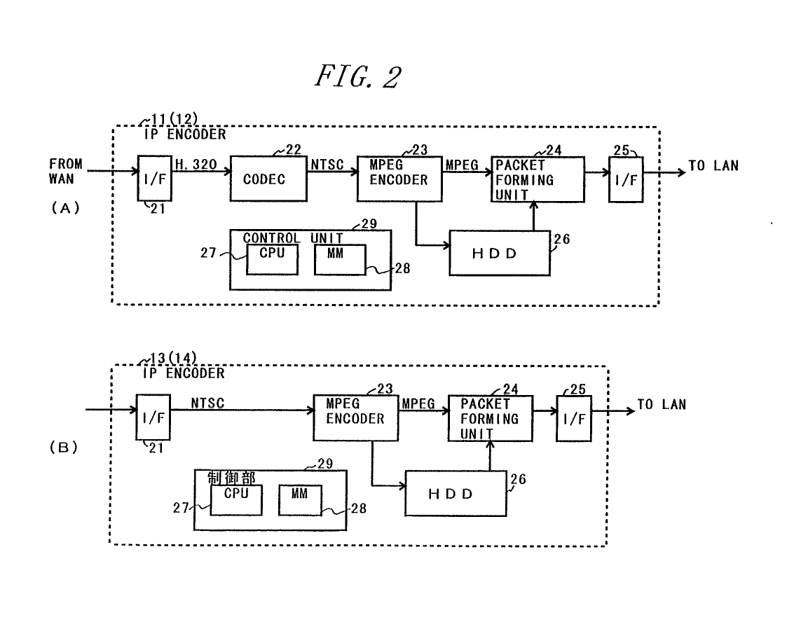

FIG. 2A is a diagram of the configuration of each of the IP encoders 11 and 12 shown in FIG. 1. The IP encoder 11 will be described as an example. The IP encoder 11 comprises an interface circuit (I/F) 21 on the camera side, a CODEC 22 connected to the I/F 21, an MPEG encoder 23 (corresponding to the compression coding unit according to the present invention) connected to the CODEC 22, a packet forming unit 24 connected to the MPEG encoder 23, an I/F 25 (corresponding to the transmission unit according to the present invention) on the LAN 7 side connected to the packet forming unit 24, a hard disk drive (HDD: including a hard disk: corresponding to the storage device according to the present invention) 26, and a control unit 29 including a CPU 27 and a main memory (MM) 28.

The CODEC 22 converts the H. 320 signal received from the WAN 16 through the I/F 21 into an NTSC signal to input the NTSC signal to the MPEG encoder 23.

The MPEG encoder 23 performs compression coding to the input NTSC signal to convert the NTSC signal into MPEG (MPEG 1 or MPEG 4) data (corresponding to video information). The MPEG data is input to the packet forming unit 24 and stored in the hard disk drive 26.

The packet forming unit 24 forms and outputs a packet including the MPEG data input from the MPEG encoder 23. When the packet forming unit 24 distributes a video image photographed by the camera C1 to the first clients 1 to 3 on real time, the packet forming unit 24 forms a UDP multicast packet including the MPEG data of the video images. On the other hand, when the packet forming unit 24 transfers the MPEG data stored in the HDD 26 to the video server 8, the packet forming unit 24 forms a TCP packet including the MPEG data.

The I/F 25 transmits the packet (UDP multicast packet or the TCP packet) input from the packet forming unit 24 to the LAN 7.

In this manner, the MPEG data of the video image photographed by the camera C1 is multicasted without being temporarily stored. In this manner, a present video image (live video image) photographed by the camera C1 is distributed to the first clients 1 to 3. Therefore, the first clients 1 to 3 can display the live video image of the camera C1 with a delay time which is shorter than that of a conventional system.

The HDD 26 stores the MPEG data of a predetermined period of time (e.g., 2 hours) output from the MPEG encoder 23 while updating the MPEG data at any time. The MPEG data stored in the HDD 26 is transferred to the videoserver 8 at a predetermined timing.

The control unit 29 is constituted by the CPU 27, the MM 28, a ROM (not shown), and the like. When the CPU 27 executes an operating system (OS) or a firmware recorded on the ROM to control a data format conversion process performed by the CODEC 22 and the MPEG encoder 23, a packet forming process performed by the packet forming unit 24, a write/read process of MPEG data performed by the HDD 26, and the like.

FIG. 2B is a diagram of the configuration of the IP encoder 13 shown in FIG. 1. The IP encoder 13 is the same as the IP encoder 11 except that the IP encoder 13 does not comprise the CODEC 22. However, the IP encoder 13 does not transmit a TCP packet including the MPEG data stored in the HDD 26 to the video server 8, and the IP encoder 13 forms a TCP packet including the MPEG data stored in the HDD 26 to transmit the TCP packet to the LAN 7 at a request of on-demand distribution from the first client 1.

The IP encoder 14 has the same configuration as that of the IP encoder 13 except that the IP encoder 14 does not comprise the HDD 26. The IP encoder 14 performs only transmission (real-time distribution of a live video image) of a UDP multicast packet including MPEG data.

In place of the above configuration, the MPEG data stored in the HDDs 26 of the IP encoders 11 and 12 may be designed to be distributed to the first clients on demand. The MPEG data stored in the HDD 26 of the IP encoder 13 may be designed to be transferred to the video server 8. The IP encoder 14 may comprise the HDD 26, so that the MPEG data stored in the HDD 26 is collected and stored by the video server 8 or distributed on demand to the first clients.

The CODEC 22 is an option which is mounted when the IP encoder receives an H. 320 signal. The CODEC 22 is not required when the IP encoder receives an NTSC signal.

In this embodiment, the MPEG encoder 23 is designed to convert an NTSC signal into MPEG data. However, the MPEG encoder 23 may be designed to convert an H. 261 signal into MPEG data.

<First Client>

Each of the first clients 1 to 3 is constituted by a personal computer (PC) comprising a display for displaying video images photographed by the cameras C1 to C4, a workstation (WS), a computer corresponding to a host device.

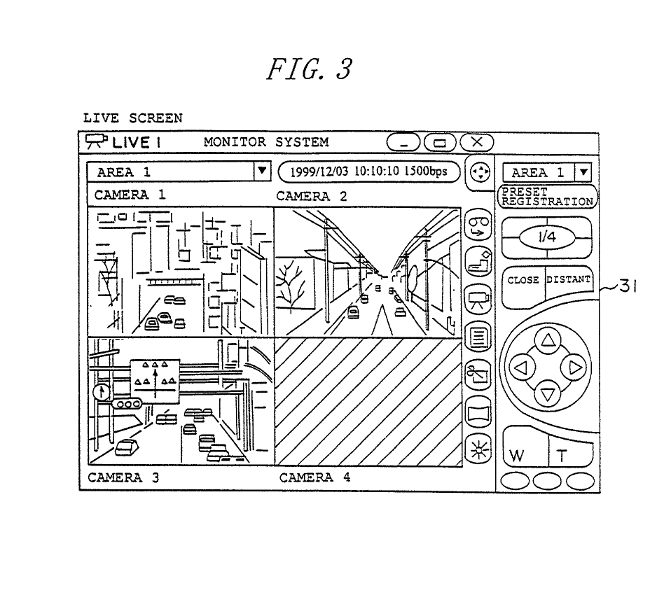

FIG. 3 is an illustration showing a display example of a live screen 31. The live screen can be substantially united into one window-like user interface as shown in FIG. 3. In the window-like live screen 31 as described above, an image display unit which can display a video image at a desired point (area) and an operation unit (illustrated on the right side toward the screen in FIG. 3) comprising interactive function buttons. If necessary, a plurality of live screens 31 of different area video images to be displayed can be also opened (displayed).

Each of the first clients 1 to 3 operates the plurality of function buttons arranged on the operation portion on the live screen 31 with a pointing device or the like, so that the display devices of various live screens 31 can be selected. More specifically, searching and selection of an area to be displayed, camera control operations such as enlargement/reduction of an area video image which is being displayed, movement of an image pickup angle, and adjustment of focus can be performed, past video images stored in the IP encoder (to be also described) or the video server 8 can be referred to, and write, edition, and the like of a comment document can be performed.

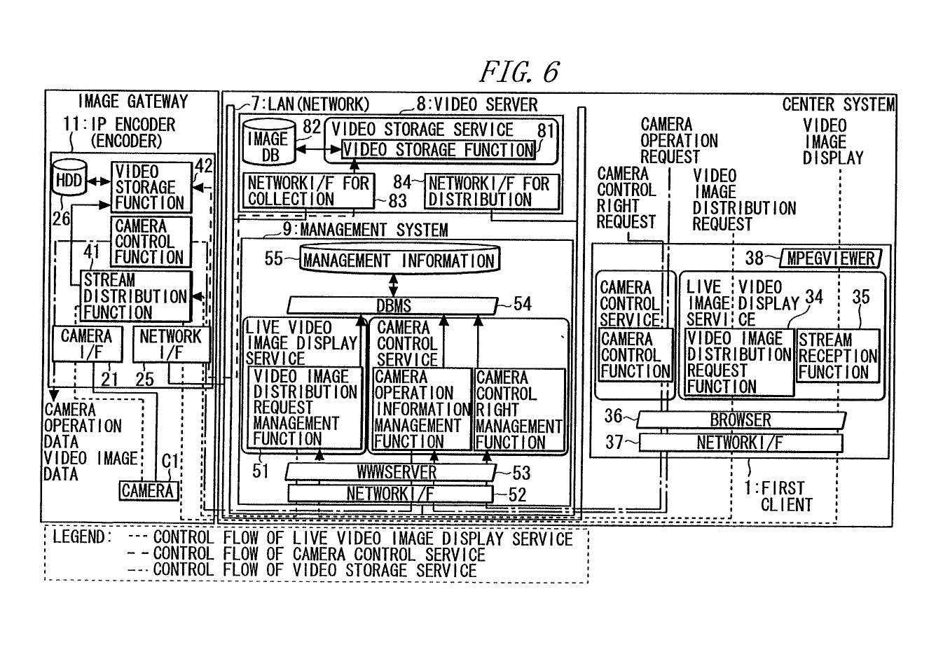

Each of the first clients 1 to 3 has a video image distribution request function 34 (see FIG. 6). More specifically, each of the first clients 1 to 3 requests the management system 9 to perform real-time distribution of video images photographed by the cameras C1 to C4.

Each of the first clients 1 to 3 has a stream receiving function 35 (see FIG. 6). More specifically, the first clients 1 to 3 receive UDP multicast packets multicasted from the IP encoders 11 to 14, and display video images based on MPEG data included in the packets on the live screen 31 (see FIG. 3) of the display. In this manner, a video image at a monitoring position is displayed on real time.

The user of the first clients 1 to 3 refers to the displayed real-time video image, so that the user can monitor the present state of the monitoring position. Each of the first clients 1 to 3 comprises a loudspeaker for outputting a sound to output a sound obtained by -microphones held by the cameras C1 to C4 from the loudspeaker. The first clients 1 to 3 store the video images which are distributed on real time in the storage devices held by the first clients 1 to 3 as needed.

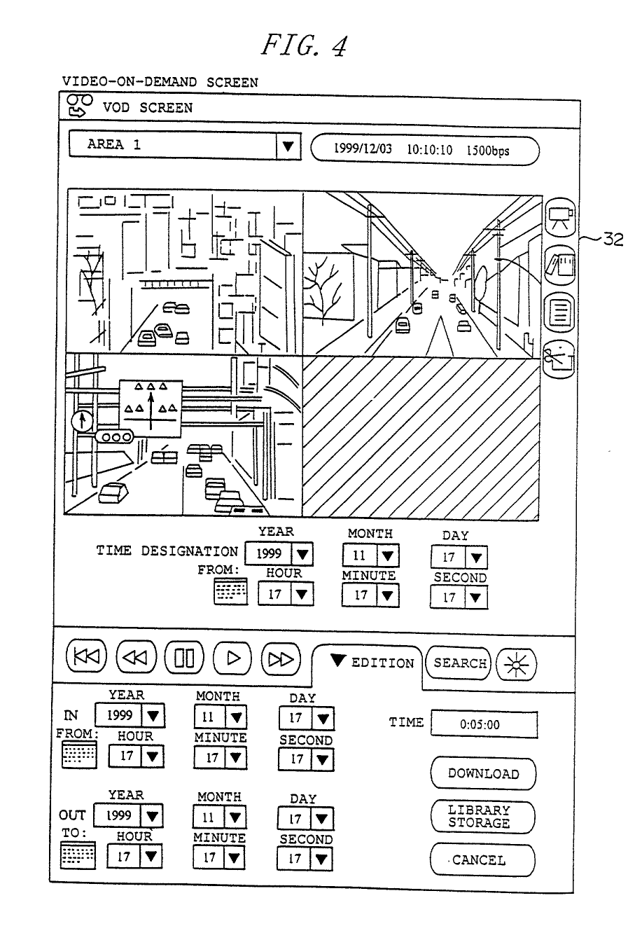

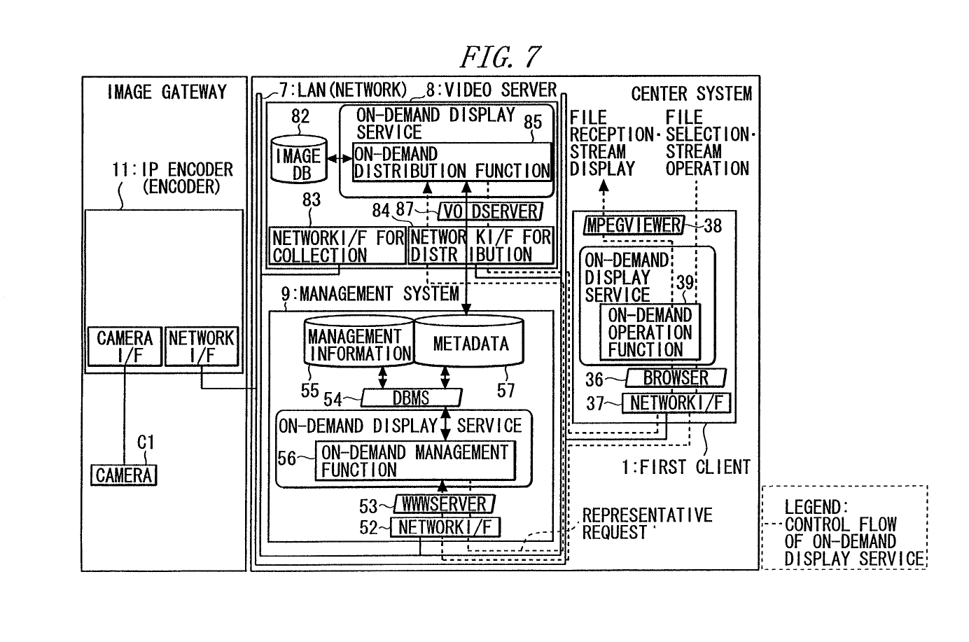

The first client 1 has an on-demand operation function 39 (see FIG. 7). More specifically, the first client 1 requests the video server 8 to provide (on-demand distribution) desired MPEG data (video image) stored in the video server 8. Thereafter, when the first client 1 receives the video image stored in the video server 8, the video image is displayed on a video-on-demand screen 32 (VOD screen 32: see FIG. 4) of the display. In this manner, the user of the first client 1 can refer to the past video image of the monitoring position.

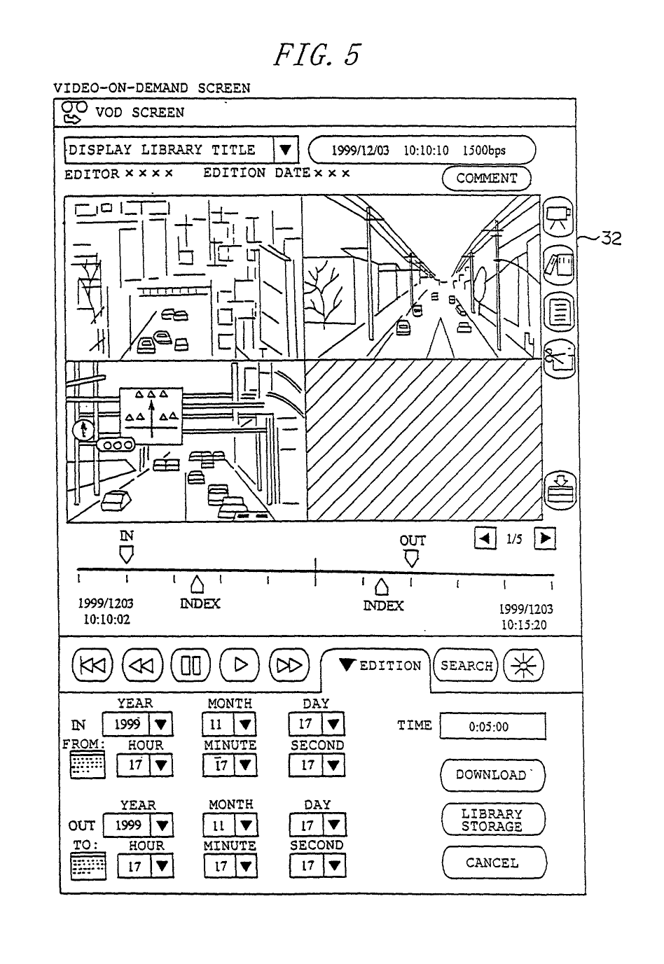

The first client 1 requests the on-demand operation function 39 to provide (on-demand distribution) of images (to be referred to as “library images”) edited and stored by the video server 8. Thereafter, when the first client 1 acquires the library images stored in the video server 8, the library images are on the VOD screen 32 (see FIG. 5).

In addition, the first client 1 requests the on-demand operation function 39 to perform on-demand distribution of a desired video image stored in the HDD 26 of the IP encoder 13. Thereafter, when the first client 1 acquires the desired video image stored in the HDD 26 of the IP encoder 13, the video image is displayed on the VOD screen 32 (see FIG. 4) of the display device. In this manner, the user of the first client 1 can also refer to the past video image of the monitoring position. The first client 1 stores the video image or the library images subjected to on-demand distribution in the storage device held by the first client 1 as needed.

When the user of the first client 1 requests on-demand distribution, the user designates a monitoring position or a camera and a photographing period (start time and end time) of the camera. In this case, a request message for on-demand distribution including the information of the camera and the photographing period is supplied from the first client 1 to the management system 9. The management system 9 specifies a position where a corresponding video image is stored on the basis of the information of the camera and the photographing period, and acquires the corresponding video image from the specific position to give the video image to the first client In this example, when the first client 1 requests a video image of the camera C1 or the camera C2, the management system 9 acquires a desired video image stored in the video server 8. In contrast to this, when the first client 1 requires a video image of the camera C3, the management system 9 acquires a desired video image stored in the HDD 26 of the IP encoder 13.

The first client 1 can display the video images or the library images which are distributed to the live screen 31 on demand. In contrast to this, the first client 1 can display a video image subjected to stream distribution (real-time distribution) on the VOD screen 32. In addition, the live screen 31 and the VOD screen 32 can also be displayed at once. In this manner, the user of the first client 1 can refer to a present video image, a past video image, and a library image at once.

<Video Server>

The video server 8 is constituted by using a computer comprising a storage device (not shown) such as an HDD functioning as an image database (image DB 82: see FIGS. 6 and 7). The video server 8 has a correction/storage function (video storage function 81: see FIG. 6) of MPEG data (video image) stored in the HDD 26 of the IP encoder.

More specifically, the video server 8, according to a predetermined schedule (e.g., a collection interval of 3 to 5 minutes) or an external trigger (e.g., an instruction from the management system 9 or the first client 1), requests the IP encoders 11 and 12 to transfer the MPEG data stored in the HDD 26, and stores the MPEG data transferred at the request to the image DB 82 as a video image file. The schedule is formed by the management system 9 and registered on the video server 8.

The video server 8 has a video data edition function. More specifically, the video server 8 executes a cut process for images, a merge process, and a capture process for still images by using the video image file stored in the image DB 82. The video server 8 also performs a superimpose process, a telop insertion process, an inter-media synchronization process (SMIL or the like), audio edition, frame adjustment, and the like if necessary. The video server 8 stores library images formed by an edition process using the video data edition function in the image DB 82 as a library image file.

The video server 8 has an on-demand distribution function 85 (see FIG. 7). More specifically, the video server 8, at a request from the management system 9 which receives an on-demand distribution request from the first client 1, reads a corresponding video file or a corresponding library image file from the image DB 82 to distribute the file to the first client 1.

In place of the above configuration, the first clients 1 to 3 may directly request the video server 8 to perform on-demand distribution of the video file or the library image file stored in the image DB 82.

In addition, the video server 8, at a request from the distribution server 10, reads the corresponding video image file or the corresponding library image file from the image DB 82 to give the file to the distribution server 10. At this time, the distribution server 10 the video image file or the library image file received from the video server 8 to the second clients 4 to 6 or any one of the second clients 4 to 6 through the Internet 19.

In this embodiment, all the video images temporarily stored in the HDDs 26 of the IP encoders 11 and 12 are stored in the video server 8. However, when users of the first clients 1 who do not require video images older than video images of the period in which video images can be stored in the HDDs 26 of the IP encoders 11 and 12, i.e., when it is satisfactory that the video images stored in the HDDs 26 of the IP encoders 11 and 12 are used, the video server 8 may not be arranged. Even in the above case, the video server 8 may be prepared to store a video image required for editing the library images or only a video image which is specially required.

<Management System>

The management system 9 is constituted by using a computer such as a PC or a WS. The management system 9 has a schedule forming/managing function. More specifically, the management system 9 forms a schedule of storage of video images to register the schedule in the video server 8.

In place of this configuration, the management system 9 may form schedules of MPEG data transfer performed by the IP encoders 11 and 12 to register the schedules in the IP encoders 11 and 12. The IP encoders 11 and 12, according to the registered schedules, may transfer the MPEG data stored in the HDDs 26 to the video server 8.

The management system 9 has a video image distribution request management function 51 (see FIG. 6) for performing communication management between the first clients 1 to 3 and the IP encoders 11 to 14. More specifically, the management system 9 gives an instruction for transmitting a UDP multicast packet to the corresponding first client at request of stream distribution (real-time distribution) from the first clients 1 to 3 to a specific IP encoder. In this manner, the first client which requests stream distribution can receive the stream (UDP multicast packet) of video images from the specific IP encoder.

The management system 9 instructs the IP encoders 11 to 14 to stop real-time-distribution to the specific first client at a request from the first client or as needed. For this reason, the IP encoder which receives the instruction stops real-time distribution the specific first client.

As described above, the management system 9 controls stream distribution (real-time distribution) to the first clients 1 to 3 by the video image distribution request management function 51. For this reason, a video image photographed by a certain camera can be prevented from being provided to a certain first client.

The management system 9 has an on-demand management function 56 (see FIG. 7). More specifically, the management system 9 requests the video server 8 or the IP encoder 13 to supply stored MPEG data (video image file) or a library image file to the first client 1 in place of the management system 9 at a request of on-demand distribution from the first client 1 (representative request of distribution).

In addition, the management system 9 controls on-demand distribution to the first clients 1 to 3 by the on-demand management function 56. More specifically, the management system 9 can select a first client which receives a video image or a library image distributed on demand from the video server 8 or the IP encoder 13 by the on-demand management function 56.

In this example, only the first client 1 is set to receive a video image or a library image distributed on demand. In addition, the setting of the first client 2 and/or the first clients 3 can be changed such that the first client 2 and/or the first client 3 receives a video image or the like distributed on demand. Video images stored in the HDDs 26 of the IP encoders 11 and 12 can also set to be distributed to the first clients 1 to 3 or at least one of the first clients 1 to 3 on demand.

When the management system 9 is set to receive on-demand distribution request messages from a plurality of first clients, and the management system 9 simultaneously receive the plurality of distribution request messages, the management system 9 executes a process for the distribution requests in the order based on priority information included in these messages. More specifically, the management system 9 extracts pieces of priority information from the messages and executes a process (representative request of distribution) to the distribution request in the order of priority.

The management system 9 limits a video image or an image supplied from the video server 8 to the distribution server 10. More specifically, the management system 9 gives an instruction that only a specific type of video image or image to the distribution server 10 to the video server 8. At this time, the video server 8 receives the provided request only when the type of video image or image which is distributed by the distribution server 10 to be provided is a specific type instructed by the management system 9.

In place of the above configuration, on-demand distribution of video images stored in the video server 8 or the HDD 26 may be performed to the first clients 2 and 3, and the video image stored in the HDD 26 of the IP encoder 13 may be collected and stored in the video server 8. In this case, when each of the first clients 1 to 3 gives the on-demand distribution request message to the management system 9, the management system 9 generates a representative request of distribution as follows on the basis of photographing time designated by the message.

More specifically, when a desired video image is stored in only the HDD 26 of the IP encoder, the management system 9 gives the representative request of distribution to the corresponding IP encoder. In contrast to this, when the desired video image is stored in only the video server 8, and when the desired video image is stored in the HDD 26 and the video server 8, the management system 9 gives a representative request of distribution to the video server 8.

In this manner, when the first clients 1 to 3 give on-demand distribution request messages to the management system 9, the first clients 1 to 3 can receive a desired video image without considering a storage position of the desired video image.

The function of the management system 9 is given to the video server 8, so that the management system 9 can also be omitted. However, in order to reduce the processing load on the video server 8, the management system 9 is arranged independently of the video server 8.

<Distribution Server>

The distribution server 10 is arranged by using a computer. The distribution server 10 functions as the proxy server of the second clients 4 to 6 connected through the Internet 19.

More specifically, at requests from the second clients 4 to 6, the distribution server 10 receives a video image or image corresponding to the request from the video server 8 to transmits the video image or the image to the corresponding second client.

When a request from any one of the second clients 4 to 6 is made by the setting of the distribution server 10 or an external trigger, the distribution server 10 acquires a video image or an image corresponding to the request to multicast the video image or the image to the second clients 4 to 6.

The distribution server 10, by the setting of the distribution server 10 or an external trigger, receives a specific kind of image from the video server 8 according to a predetermined schedule and transmits each of the second clients 4 to 6 or any one of the second clients 4 to 6.

The distribution server 10 stops distribution of a video image or an image corresponding to a specific second client according to an external trigger (e.g., an instruction from the management system 9).

In place of the above configuration, the following configuration may be used. That is, the distribution server 10 receives a video image stored in the HDD of an IP encoder to transmit the video image to the second client.

<Second Client>

Each of the second clients 4 to 6 is constituted by a PC, a WS, a mobile computer or the like comprising a display. Each of the second clients 4 to 6 requests the distribution server 10 to distribute a video image, so that each of the second clients 4 to 6 receives video images of the cameras C1 to C4 stored in the video server 8 to display the video images on the display.

<Other>

In the network system shown in FIG. 1, the first client 1 executes control (pan adjustment of a camera, tilt adjustment, and volume adjustment of a microphone and a loudspeaker) of the cameras C1 and C3.

More specifically, the first client 1 operates a monitor screen to request the management system 9 to control the camera C1. A this time, the management system 9 outputs a control signal for the camera C1. The output control signal is input to the camera C1 through the LAN 7 and the CODEC 22, the WAN 16, and the CODEC 15 of the IP encoder 11, and an operation depending on the control signal is executed in the camera C1.

When the first client 1 requests the management system 9 to control the camera C3, a control signal from the management system 9 is input to the camera C3, and the camera C3 operates on the basis of the control signal.

[Operation in Network System]

An operation in the network system will be described below.

<Live Video Image Display>

FIG. 6 is a diagram for explaining an operation example of a live video image display and video storage in the network system shown in FIG. 1. In FIG. 6, as the operation example, an example in which-a video image photographed by the camera C1 is displayed as a live video image (real-time display) by the first client 1.

As shown in FIG. 6, when the live video image is displayed, the first client 1 functions as a device comprising the video image distribution request function 34, the stream receiving function 35, a browser 36, a network interface (I/F) 37 to the LAN 7, an MPEG viewer 38, and a cameral control function such that a processor (not shown) (e.g., a CPU) held by the first client 1 executes a program.

The management system 9 functions as a device comprising the video image distribution request management function 51, a network interface (I/F) 52 to the LAN 7, a WWW server 53, a DBMS 54, management information 55, a camera operation information management function, and a camera control right management function such that a processor (not shown) (e.g., a CPU) held by the management system 9 executes a program.

In addition, the IP encoder 11 functions as a device comprising I/Fs 21 and 25, the HDD 26, a stream distribution function 41, a video storage function 42, and a camera control function such that the CPU 27 executes a program.

The stream distribution function 41 is realized by the CODEC 22, the MPEG encoder 23, the packet forming unit 24, and the control unit 29, and the video storage function 42 is realized by the packet forming unit 24, the HDD 26, and the control unit 29.

At the first, a user of the first client 1 inputs a video image distribution request of the camera C1 to the first client 1. At this time, the video image distribution request function 34 forms a real-time distribution request message of a video image photographed by the camera C1 and transmits the real-time distribution request message from the I/F 37 to the management system 9. The transmitted request message is received by the I/F 52 of the management system 9 through the LAN 7 to give the request message to the video image distribution request management function 51.

In this case, the video image distribution request management function 51 refers to the management information 55 to check whether the video image distribution request management function 51 may accept the request from the first client 1 or not. The video image distribution request management function 51 accepts the request, the video image distribution request management function 51 updates the management information 55 by the check result.

Thereafter, the video image distribution request management function 51 transmits a real-time distribution request message from the I/F 52 to the IP encoder 11. The transmitted request message is received by the I/F 25 of the IP encoder through the LAN 7 and received by the stream distribution function 41.

In this case, the stream distribution function 41 adds the address of the first client 1 to the destination address of a UDP multicast packet transmitted to the LAN 7. Thereafter, when the H. 320 signal of a video image photographed by the camera C1 is input to the I/F 21, the stream distribution function 41 forms a UDP multicast packet including MPEG data corresponding to the H. 320 signal to multicast the UDP multicast packet from the I/F 25 to the LAN 7. The multicasted UDP multicast packet is received by the I/F 37 of the first client 1 and input to the stream receiving function 35 through the browser 36.

In this case, the stream receiving function 35 extracts the MPEG data from the UDP multicast packet to give the MPEG data to the MPEG viewer 38. At this time, the MPEG viewer 38 displays a live video image of the camera C1 based on the MPEG data on the live screen 31 which is displayed on the display in advance (see FIG. 3).

In this manner, a user of the first client 1 refers to the video image which is lively displayed, so that the user can monitor an event occurring at a point (area) at which the camera C1 is arranged.

<Video Storage>

An operation example of video storage in the network system shown in FIG. 1 will be described below with reference to FIG. 6. As shown in FIG. 6, in a video storage operation, a CPU (not shown) held by the video server 8 executes a program, so that the video server 8 functions as a device comprising a video storage function 81, an image DB 82, and I/Fs 83 and 84.

In FIG. 6, the stream distribution function 41 of the IP encoder 11 receives the H. 320 signal of the video image photographed by the camera C1, forms MPEG data corresponding to the received H. 320 signal, and gives the MPEG data to the video storage function 42.

In this case, the video storage function 42 stores the MPEG data received from the stream distribution function 41 in the hard disk in the HDD 26. In this manner, the video image of the camera C1 is stored in the HDD 26 of the IP encoder 11.

On the other hand, the video storage function 81 of the video server 8 is started according to a schedule which is recorded by the management system 9 in advance to form a MPEG data transfer request message. The formed request message is given to the video storage function 42 through the I/F 83, the LAN 7, and the I/F 25.

The video storage function 42 reads MPEG data to be transferred from the HDD 26, forms a TCP packet including the read MPEG data, and transmits the TCP packet from the I/F 25 to the LAN 7. The transmitted TCP packet is received by the I/F 83 of the video server 8 through the LAN 7 and given to the video storage function 81.

The video storage function 81 extracts the MPEG data from the TCP packet to store the MPEG data as a video image file in the image DB 82. An operation similar to this is also performed between the video server 8 and the IP encoder 12. Therefore, the MPEG data stored in the HDDs 26 by the IP encoders 11 and 12 are stored in the image DB 82 of the video server 8.

<On-demand Display>

FIG. 7 is a diagram for explaining an operation example of an on-demand display in the network system shown in FIG. 1. FIG. 7 shows an operation example in which the first client 1 accepts on-demand distribution from the video server 8.

As shown in FIG. 7, in an on-demand display, the first client 1 functions as a device comprising the browser 36, the I/F 37, the MPEG viewer 38, and the on-demand operation function 39.

The video server 8 functions as a device comprising the image DB 82, the I/Fs 83 and 84, the on-demand distribution function 85, and a VOD server 87. In addition, the management system 9 functions as a device comprising the I/F 52, the WWW server 53, the DBMS 54, the management information 55, the on-demand management function 56, and a meta-data 57.

As a presumption, the VOD screen 32 shown in FIGS. 4 and 5 is displayed on the display of the first client 1. A user of the first client 1 operates buttons displayed on the VOD screen 32 to execute a file selection operation or a stream operation.

In this manner, the on-demand operation function 39 acquires specific information of a monitoring position (camera) designated by the user and information of a photographing period to form an on-demand distribution request message including the acquired information. The formed request message is transmitted to the LAN 7 through the browser 36 and the I/F 37 and received by the on-demand management function 56 through the I/F 52 and the WWW server 53 of the management system 9.

In this case, the on-demand management function 56 refers to the management information 55 and the meta-data 57 to specify a monitoring position included in the request message of the first client 1 and a storage position of a video image corresponding to the information of the photographing period. In this example, it is assumed that the video image is stored in the image DB 82 of the video server 8.

Thereafter, the on-demand management function 56 acquires data required to form a representative request message from the management information 55 and the metadata 57 and updates the management information 55 or the metadata 57 as needed.

Thereafter, the on-demand management function 56 forms a representative request message of distribution of a video image or a library image to the video server 8 on the basis of information (information of a monitoring position and a photographing period) included in the message from the first client 1 and information obtained from the management information 55 and the metadata 57.

The formed representative request message is transmitted to the LAN 7 through the WWW server 53 and the I/F 52 and received by the on-demand distribution function through the I/F 84 of the video server 8.

In this case, the on-demand operation function 39 refers to the information included in the representative request message to detect a corresponding video image file (or a library image file) from the image DB 82.

The detected video file is transmitted from the on-demand distribution function 85 to the LAN 7 through the VOD server 87 and the I/F 84. In this manner, on-demand distribution of a video image to the first client 1 is performed.

The video file transmitted to the LAN 7 is received by the on-demand operation function 39 through the I/F 37 and the browser 36 of the first client 1. At this time, the on-demand operation function 39 gives the received video image file to the MPEG viewer 38.

In this case, the MPEG viewer 38 displays a video image (past video image) based on the video image file in the VOD screen 32 displayed on the display device (file reception and stream display). In this manner, the user of the first client 1 can refer to a desired video image.

[Operation of Embodiment]

In the network system according to the embodiment of the present invention, information (video information) of video images photographed by the cameras C1 to C4 are multicasted from the IP encoders 11 to 14 to the first clients 1 to 3 without being temporarily stored.

In this manner, unlike a conventional system, delay caused such that the video information is temporarily stored and then distributed does not occur. For this reason, a delay time from when a video image is photographed to when the video image is displayed by a client can be reduced in comparison with the conventional system.

Therefore, a proper reaction faster than that of the conventional system can be made to an event occurring for the monitoring position. When video information is multicasted, the video information can be distributed to clients faster than distribution performed by repeating uni-casting to a plurality of destinations.

When the HDDs 26 are arranged in the IP encoders 11 to 13, unlike a conventional system, video images need not be simultaneously stored in a server. In addition, the video server 8 does not perform real-time distribution.

In this manner, the processing load on the video server 8 is smaller than that of a conventional system. For this reason, when the video server 8 is requested to perform on-demand distribution, the processing load on the video server 8 does not increase unlike the conventional system. For this reason, a process for an on-demand distribution request is prevented from being delayed.

In addition, when it is satisfactory that video images stored in the HDD 26 are used, the video server 8 for on-demand distribution of the video image is not necessary. For this reason, the cost required to construct a network system can be suppressed.

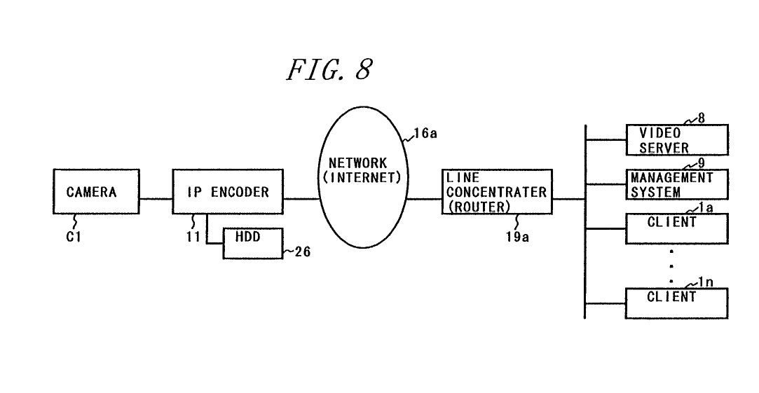

The network system of the present invention can be constituted as the network configuration shown in FIG. 8. More specifically, the network system can be constituted as follows. That is, the camera C1 and the IP encoder 11 are directly connected to each other, the IP encoder 11 is connected to a line concentrater (router) 19a through a network 16a (corresponding to another network in the second invention), and the line concentrater (router) 19a is connected to clients 1a to in constituting a center system and the LAN 7 accommodating the video server 8 and the management system 9.

In the network configuration shown in FIG. 8, when the IP encoder 11 is designed to store a video image photographed by the camera C1 without any condition, the center system performs monitoring by a real-time display. When a user recognizes the occurrence of an event, the video image can be collected from the HDD 26 to the video server 8 in the IP encoder As described above, only a video image required for the video server 8 can be designed to be stored. For this reason, a network (LAN 7) used to collect video images can be efficiently used. More specifically, lines can be prevented from being continuously busy due to video image collection performed by a video server.

In the network configuration shown in FIG. 8, unlike the network configuration shown in FIG. 1, the IP encoder 11 transmits video information including multicast designation to the line concentrater (router) 19a, and the router 19a multicasts the video information to the clients 1a to 1n.

What is claimed is:

1. A network system for distributing video information to a plurality of clients comprising:
a network for accommodating the plurality of clients; and
an encoder connected to the network, and wherein the encoder comprises a compression coding unit compressing and encoding to inputted video information, a packet forming unit forming a packet comprising the compressed and encoded video information, and a transmission unit multicasting the formed packet to the plurality of clients through the network.

2. A network system according to claim 1, further comprising a storage device for storing video information subjected to compression coding by the compression coding unit, and
wherein the video information stored in the storage device is distributed at requests from the clients.

3. A network system according to claim 2, wherein part or all of the video information stored in the storage device is stored by another storage device.

4. A network system according to claim 3, wherein the other storage device is a video server which is connected to the network, collects and stores the video information stored in the storage device, and distributes the stored video information at requests from clients.

5. A network system according to claim 4, further comprising a management device connected to the network, and wherein the management device receives distribution requests for the video information stored in the storage device or the video server from a client, and executes a distribution process for distributing video information corresponding to the distribution requests to the corresponding client.

6. A network system according to claim 5, wherein, the management device, when respectively receives a plurality of distribution requests which priority is set from a plurality of clients, executes a distribution process corresponding to each of the distribution requests in the order of the set priorities.

7. A network system according to claim 5, wherein the management device limits a client for acquiring video information stored in the storage device or the video server.

8. A network system according to claim 5, further comprising another network connected to the network and accommodating another single client or a plurality of other clients, and
wherein the video information stored in the storage devices or the video server are distributed at a distribution request from the other client.

9. A network system according to claim 8, further comprising a distribution server, connected to the network and the other network, distributing the video information stored in the video server to the other network.

10. A network system according to claim 1, further comprising another network connected to the encoder and a video input device connected to the other network, and
wherein the encoder receives video information inputted to the video input device through the other network.

11. A network system according to claim 1, further comprising a video device connected to the encoder, and wherein the encoder receives video information input to the video input device.

12. A network system for distributing video information to a plurality of clients, comprising:
an encoder compressing and encoding inputted video information, forming a packet comprising the compressed and encoded, and transmitting the formed packet to a network; and
a concentrater accommodating the plurality of clients through communication lines, receiving the packet transmitted by the encoder through the network, and muluticasting the received packet to the plurality of clients.

13. A network system according to claim 1, wherein the encoder compresses and encodes a plurality of inputted video signals.

14. An encoder for distributing video information to a plurality of clients through a network, comprising:
a compression coding unit compressing and encoding inputted video information;
a packet forming unit forming a packet comprising the compressed and encoded video information; and
a transmission unit multicasting the formed packet to the plurality of clients.
